(19) United States
(12) Patent Application Publication
(10) Pub. No.: US 2020/0122761 A1
(43) Pub. Date: Apr. 23, 2020

(54) A TRANSPORT CART

(71) Applicants: Vladimír Fila, Jihlava (CZ); Lukás Wochner, Jihlava (CZ)

(72) Inventors: Vladimír Fila, Jihlava (CZ); Lukás Wochner, Jihlava (CZ)

(21) Appl. No.: 16/623,101

(22) PCT Filed: Jun. 14, 2018
(86) PCT No.: PCT/CZ2018/000028

§ 371 Date: Dec. 16, 2019

(30) Foreign Application Priority Data
Jun. 15, 2017 (CZ) PUV 2017-33813

(51) Int. Cl. B62B 3/00; B62B 5/06

(52) U.S. Cl. CPC B62B 3/001; B62B 2301/10; B62B 5/06; B62B 3/008

(57) ABSTRACT

A transport truck for transport of components, pellets, gitterboxes and similar is in the bottom part of a main frame equipped with at least one couple of vertical fixed pins for pivoting connection in the range of 360° into laterally deflected forks in which are pivoted wheels where the essence of the invention consist in that between the front and the rear wheels is transversally pivoted a shaft whose end parts are placed in bearing housings and are firmly fixed to pivoted scooter forks which are a fastener of foldable revolving wheels and the pivoted shaft is firmly fixed to at least one one-arm lever whose second end part is fixed, by the help of a pin, to control mechanical or mechanical-hydraulic means which are connected through a pin connection with a lever arm of a control lever which is together with a scooter fork with holes of a multifunctional shaft pivoted on a pin placed in a holder which is firmly fixed to the main frame of the transport truck.

### ART DOMAIN

The technical design concerns a transport truck for transport of components, pallets, gitterboxes and similar, which is on the bottom side of a main frame equipped with at least one couple of vertical fixed pins for pivoting in the range of 360° into the side of laterally deflected scooter forks in which are pivoted wheels.

### PRESENT PRIOR ART

The transport trucks are a significant part of manipulation management which is used in the most diverse production branches, storage management and similar especially for transport of components, substances, pallets, beer crates etc. Diversity of use of transportation and manipulation technology requires also various claims. Due to this we know many technical designs of transport trucks which are above all used for specific use, as is, for example transport of barrels, different types of pallets, crates, boxes and so on. One from main targets of these existing technical designs is the easiest manipulation, simple control and also is essential their operational reliability with the lowest possible maintenance demand. Specific use of this transport means has influence on relative lower requirements for a movement trajectory range which reduces wider use of these technical designs in other various areas.

There are widely known transport trucks which consist of a main frame, generally rectangle shaped, which is on the bottom part equipped with at least one couple of wheels, revolving around the vertical as well as the horizontal axis. Common design of transport trucks with this technical and structural conception is design where all the wheels, which are placed in the corners of the main frame from the bottom part of the transport truck, are pivoted around the horizontal and also the vertical axis. Movement of the transport truck on floor surface is dependent on direction of application of the outer pushing force along its outer perimeter for example behind the side plates of a pallet gitterbox. This way controlled transport truck when is used a relatively considerable force demandingness reliably makes transport movement in a single direction of wheels setting. Actual setting of direction of wheels corresponds with position in which was done the last transport movement. For another direction of transport movement which is not identical with the previous movement is generally necessary to manually set the wheels into desired direction and/or is necessary to use a considerable force along the outer perimeter of the transport truck for wheels to overcome the resistance resulting from their different setting and to get into position corresponding with direction of resulting power vector which acts on the outer perimeter of the transport truck. Similarly there comes to this problem in cases when the transport trajectory of the transport truck is in curves, contains sharp turns or manipulation to sides etc. From operational practice is known that when significant changes occur in direction there comes to such setting of the wheels which partially worsens or in some cases completely blocks required change of movement direction. This problem causes necessity of a significant force which is necessary for control of the transport truck and at the same time increases requirements for manipulation space necessary for the operator who controls this truck. One measure which should improve conditions for manipulation is that the wheels are equipped with radial bearings and their forks are pivoted on a fixed vertical pin, are laterally deflected into side and enable their rotary movement in the range of 360° and are equipped with axial bearings.

### ESSENCE OF THE TECHNICAL DESIGN

The target of presented design is, through a relatively simple and in practice longtime tested mechanisms, to equip the transport trucks with existing structural conception with technical means which will enable improvement of their control ability, will improve variability of use and will decrease physical demandingness for manipulation even with regard to increasing weight of transported objects and goods.

Transport trucks which are used in warehouses, production and assembly workshops and similarly for transport of various products, goods and components are on the bottom part of the main frame equipped with axially as well as radial way pivoted wheels whereas between the front and rear wheels is transversally pivoted shaft whose end parts are placed in bearing housings and are firmly connected with pivoted scooter forks which are fastener of folding wheels and the pivoted shaft is firmly connected with at least one one-arm lever whose second end part is connected through a pin with control mechanical or mechanical-hydraulic means through a pin connection with a lever arm which is together with fork ending of a multifunctional rod pivoted on a pin placed in a holder which is firmly fixed with the frame of the transport truck.

A variant of controllable mechanical means consists of a pull bar with one end part connected through a pin with an end part of a pivoted one-arm lever which is firmly fixed to a shaft whereas the second end part of the pull bar is through a pin connection pivoted to a lower arm of an angular triple-arm control lever and a central and also an upper arm of given lever is equipped with a through hole for connection through a slide-in pin with holes formed in fork end part of the multifunctional shaft.

For this design is advantageous when the upper arm of the three-arm control lever is equipped with a support cog which together with an inserted slide-in pin in the hole of scooter fork end part of the multifunctional shaft and with the holes in fixed holder blocks vertical position of this rod and herewith forms a firm grip spot for manipulation with the transport truck.

For this design is likewise advantageous when the support cog in the upper arm of three-arm control lever together with the inserted slide-in pin in the hole of the firm holder blocks position of setting of the wheels in a working vertical position and the horizontal position of the multifunctional shaft is in position which enables its parallel connection with another transport truck.

Variant of the technical design, especially for transport of heavier products, is based on the fact that mechanical-hydraulic control means consist of a pull bar which is by its one end part through a pin connected with a one-arm lever which is firmly fixed to a shaft and by its second end is slide controlled by a piston of a direct single-acting hydraulic piston whose pivoted control one-arm pivoting levers are through a pin and pull bars connected with a lower arm of two-arm control lever which is pivoted with a fork end part of the multifunctional shaft on a pin whose fastener is a firm holder connected with the main frame of the transport truck.

It is advantageous that the one-arm lever which is firmly fixed by its one end to the shaft is with its second end connected with a draft spring whose second end is anchored in a transport eye which is firmly fixed with the main frame of the transport truck.

It is also advantageous that the direct single-acting hydraulic piston is equipped with hydraulic locks for locking in pressing mode position of the piston connected with the pull bar.

Another variant of the technical design, which is used especially for transport of relatively heavy goods, is that there is between the front and the rear wheels transversally pivoted, next to each other, couple of shafts whose end parts are pivoted in bearing housings and firmly fixed with pivoted scooter forks which are equipped with pivoted, preferably doubled, wheels whereas these shafts are mutually connected through a connecting pull bar through pins and one-arm levers which are firmly fixed on the shafts.

It is likewise advantageous when the outer diameter of foldable revolving wheels is bigger than the outer diameter of the small wheels.

### DESCRIPTION OF THE DRAWINGS

The technical design is explained in detail by the help of the drawings where the FIG. 1 is an axonometric view from the bottom side of a standard design of the transport truck which is in corners equipped with pivoted wheels and is equipped with mechanical-hydraulic means for control of position of setting of doubled revolving wheels placed in scooter forks and firmly fixed with a revolving shaft which is transversally placed between the front and the rear wheels whereas the doubled revolving wheels are illustrated in working vertical position.

FIG. 2 is a partial axonometric view from the bottom side in a detailed zoomed scale of control lever means of mechanical-hydraulic apparatus and in a movement locked vertical position of the multifunctional shaft.

FIG. 3 is a partial axonometric view from above in a detailed zoomed scope of the control lever means of mechanical-hydraulic apparatus where is illustrated setting of particular positions of the multifunctional shaft.

FIG. 4 is a general axonometric view from the bottom side of a standard design of the transport truck which is in corners equipped with pivoted wheels and is equipped with mechanical means for control of setting of pivoted wheels namely by the help of a forks which are firmly fixed to a transversally placed pivoted shaft which is between the front and the rear wheels whereas the revolving wheels are illustrated in the working vertical position.

FIG. 5 is a partial axonometric view from above in a detailed zoomed scale of the lever means of mechanical control apparatus and a movement locked vertical position of the multifunctional shaft.

FIG. 6 is a similar lay out as in FIG. 5 with difference that the multifunctional shaft is locked in the horizontal position for connection with another transport truck.

FIG. 7 is a general axonometric view from the bottom side of a standard design of the transport truck as it is illustrated in FIG. 1 with a difference that the doubled revolving wheels are position controlled by two shafts which are placed parallel way transversally next to each other and are together connected to mechanical-hydraulic apparatus and the multifunctional shaft is movement locked in the horizontal position for connection with another transport truck.

FIG. 8 is a general axonometric view from above of design of the transport truck as is it illustrated in FIG. 7 with a difference that the multifunctional shaft is movement locked in the vertical position and doubled revolving wheels are in working position which is advantageous setting for control of manipulation with the transport truck with heavier weight.

FIG. 9 illustrates a side view of the transport truck design as it is illustrated in FIGS. 7 and 8 i.e. with a position of doubled revolving wheels in the working vertical position with lifted frame of supporting surface of the transport truck, the wheels are not in contact with the surface of the floor, the multifunctional shaft is in a vertical locked position and on the supporting surface of the transport truck is placed a gitterbox.

### EXAMPLES OF INVENTION'S TECHNICAL DESIGN

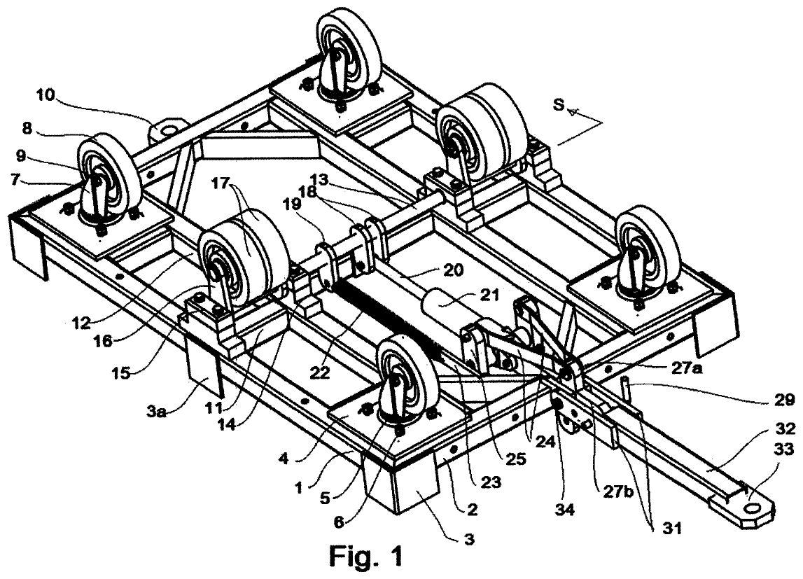

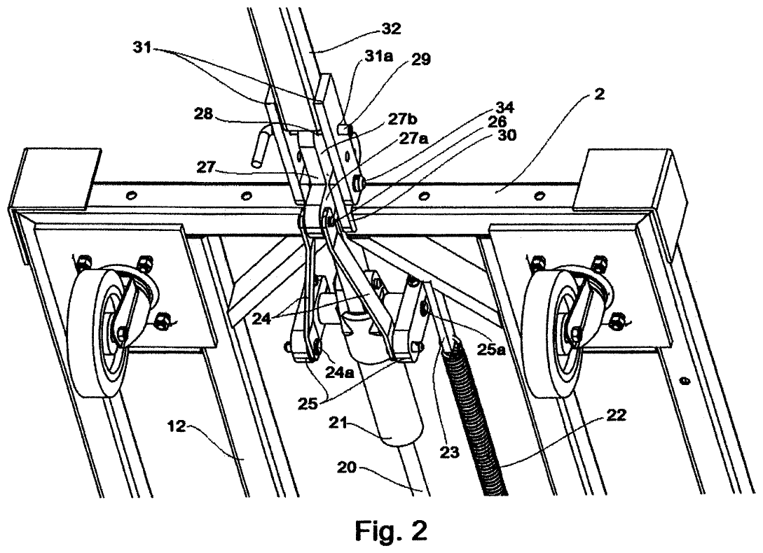

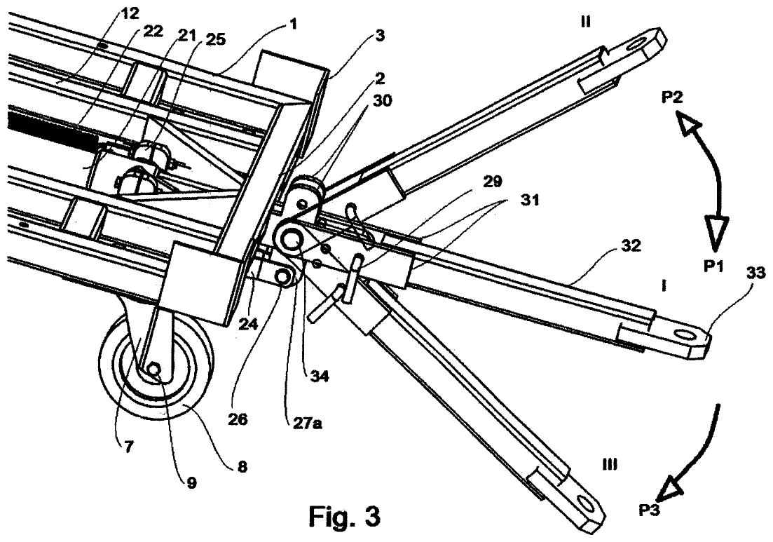

The transport truck 1 according to the FIG. 1 is formed with a main frame 2 whose loading area is along outer perimeter determined with fixed corner flat outs 3 which are completed with fixed flat outs 3a placed in the central part of the main frame 2. From the bottom part of the main frame 2 are in the corners placed main boards 4 with non-illustrated vertical pins and fasteners 5 of axial bearings by the help of screws 6. On vertical pins are pivoted side laterally deflected scooter forks 7 which are a fastener of the wheels 8 pivoted on horizontally placed shafts 9. In the rear part of the main frame 2 is firmly fixed a transport eye 10 with a hole for insertion of a non-illustrated slide-in pin. The main frame 2 is structurally reinforced with transverse porters 11 and longitudinal girders 12. In the central part of the main frame 2 is transversally placed a shaft 13 whose end parts are pivoted in inner bearing housings 14 and outer bearing housings 15 fixed to the frame 2 of the transport truck 1 and also there are, to this shaft 13, firmly fixed pivoted scooter forks 16 with pivoted revolving wheels 17. The shaft 13 is in the space between the inner bearing housings 14 firmly fixed to the end parts of one-arm levers 18 and 19. The second end part of the one-arm lever 18 is through a pin connected to the end part of a sliding rod 20 whose slide movement controls a piston of direct acting hydraulic piston 21. Second end part of the one-arm lever 19 forms a transport eye for a draft spring 22 whose second end part is fixed to the transport eye 23 which is firmly fixed to the frame 2. The direct acting hydraulic piston 21 is connected to couple of pull bars 24 which are from one side connected through pins 24a according to the FIG. 2 with a couple of pivoted one-ram levers 25 and with the second end part are firmly fixed on the shaft 25a which is a generally known control element of pressure mechanism of the direct acting hydraulic piston 21. The opposite end part of the couple of pull bars 24 is, by the help of the pin 26, pivoted way connected with an arm 27 of an angular two-arm lever 27. Second arm 27b of the angular two-arm lever 27 is equipped with a hole 28 which enables insertion of a slide-in pin 29. The main frame 2 is firmly fixed with a loading holder 30 on which is slipped over a scooter fork with holes 31 of a multifunctional shaft 32 whose second end part is equipped with a suspension hook, a hole 33 according to the FIG. 1. Fixed loading holder 30 according to the FIG. 2 is by the help of the pin 34 a common fastener of pivoted scooter fork with holes 31, multifunctional shaft 32 and angular two-arm control lever 27. The multifunctional shaft 32 can move freely in directions of arrows P₁, P₂, P₃ according to the FIG. 3 and get into position I, II, III.

By insertion of the slide-in pin 29 into the hole 28 of the arm 27b of the angular two-arm control lever 27 and into the hole 31a in the scooter fork with holes 31 of the multifunctional shaft 32 comes to a mutual connection of these components. During rocking motion of the multifunctional shaft 32 in direction of arrows hand P₂ from position I into the horizontal position II and vice versa there comes to a rocking movement of the arm 27a and the pull bars 24 of pivoted one-arm levers 25 and the shafts 25a of the direct acting hydraulic piston 21. Herewith there arises pressure on the piston of the direct action hydraulic piston 21 and the sliding rod 20 through the one-arm lever 18 turns the shaft 13. Herewith the revolving wheels 17 through the pivoted scooter forks 16 tilt from the folded position, opposite to direction of the arrow S, into a working vertical position and touch the surface of the floor and thereby comes to lifting of the main frame 2 of the transport truck 1 and the wheels 8 get into position without any contact with the surface of the floor.

If there comes to the tilt of the multifunctional shaft 32 in direction of the arrow P₃ from the horizontal position I into the lower position III there comes, by the connection of described control elements, to release of a bypass valve of the direct acting hydraulic piston 21 which starts to get into a home position thereby, at the same time, comes to termination of the pressure of the sliding rod 20 on the one-arm lever 18 and through the one-arm lever 19 and the draft spring 22 causes that the shaft 13 is turned in the way that the revolving wheels 17 leave the working vertical position and are tilted in direction of the arrow S. Herewith is terminated their contact with the surface of the floor and the main frame 2 of the transport truck 1 again touches with its wheels 8 the surface of the floor.

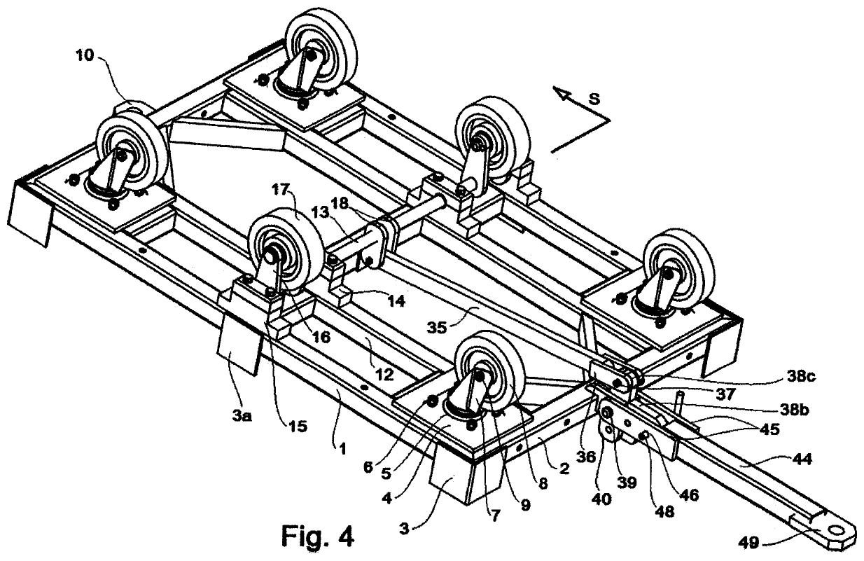

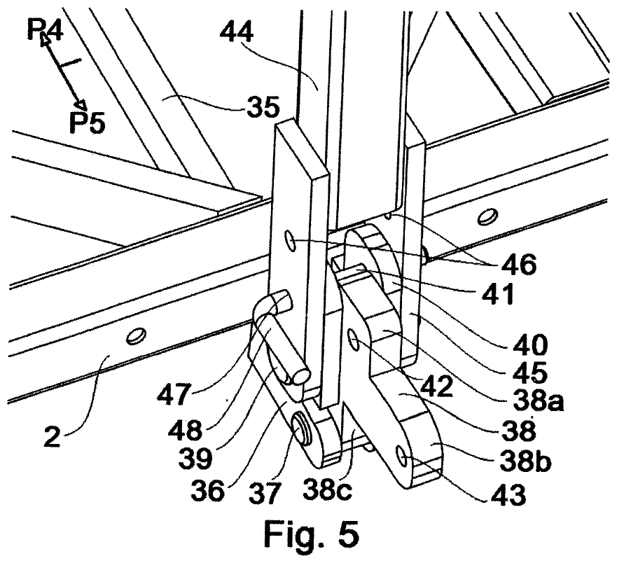

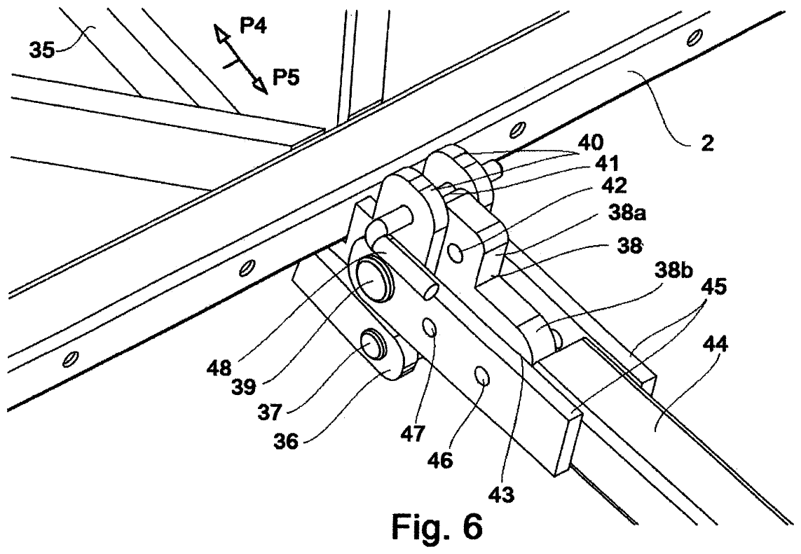

Another exemplary variant of given technical design is applicable for transport trucks 1 which are used, above all, for transport of loads with a relatively low weight and is it illustrated in FIGS. 4, 5, 6. Control of the revolving wheels 17 is done via mechanical control means.

This way there comes to positioning of the revolving wheels 17 into tilted position i.e. into the position where these revolving wheels 17 do not touch the surface of the floor, and opposite when set into the working vertical position there comes to a lift of the main frame 2 of the transport truck 1 which results in the fact that the pivoted wheels 8 do not touch the surface of the floor.

The one-arm lever 18 which is with one end part firmly fixed to the shaft 13 is with its second end part, by the help of a pin, connected to one end part of the pull bar 35 which moves in direction of the arrows P₄ and P₅. The second end part of the pull bar 35 is equipped with a scooter fork 36 which is through a pin 37 connected with a lower arm 38c of a triple-arm controlling lever 38 pivoted on the pin 39 placed in the hole in the fixed holder 40. The upper arm 38a of the triple-arm control lever 38 is equipped with a cog 41 and a hole 42 and a central arm 38b with a hole 43. The multifunctional shaft 44 is ended with a scooter fork 45 also pivoted on the pin 39. The scooter fork 45 is equipped with pass-through holes 46 and 47 which enable insertion of the slide-in pin 48. The upper end of the multifunctional shaft 44 is equipped with a hole 49 according to the FIG. 4, for insertion of a non-illustrated slide-in pin for parallel connection with another transport truck 1.

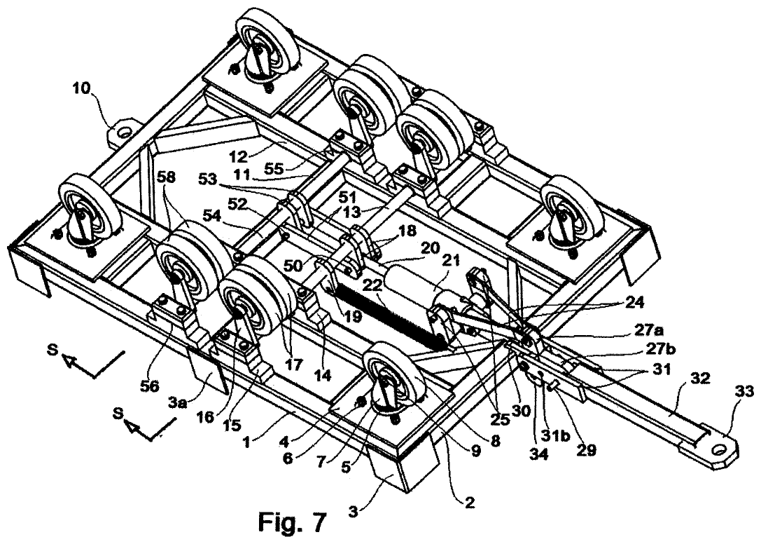

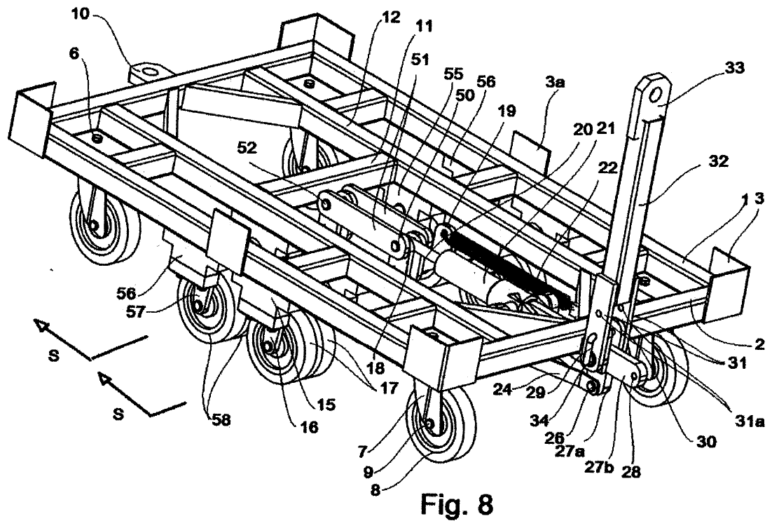

Another variant of the design of the transport truck 1 with the control mechanical-hydraulic apparatus according to objective technical design is illustrated in FIGS. 7, 8, 9. The illustration follows the illustration of the transport truck 1 from the FIG. 1 and its different structural lay out results from the fact that this type is designed for transport of a load with higher or considerable weight.

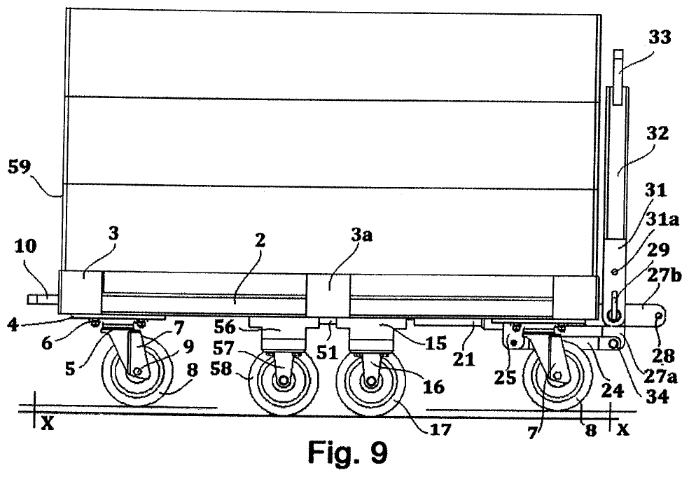

In this design is the end part of the sliding rod 20 of the direct acting hydraulic piston 21 connected through a pin 50 according to the FIG. 7 with the end part of the one-arm lever 18 which is with its second end part firmly fixed to the shaft 13 which controls the tilt movement of, preferably doubled, revolving wheels 17. On the pin 50 is also placed a couple of connecting pull bars 51 whose second end parts are via pin 52 connected with the upper end part of the one-arm levers 53 which are firmly fixed to a pivoted shaft 54 which is in a parallel way placed next to the shaft 13. The end parts of the shaft 54 are pivoted in inner bearing housings 55 and outer bearing housings 56 and are firmly fixed to pivoted scooter forks 57 equipped with pivoted double wheels 58. When the pivoted scooter forks 57 with double wheels 58 are in the working vertical position the main frame 2 of the transport truck 1 is lifted above the surface of the floor in the way that the wheels 8 are away from the surface of the floor with a distance X illustrated in FIG. 9. The main frame 2 of the transport truck 1 is for illustration drawn with a transport gitterbox 59.

### INDUSTRIAL USABILITY

Usability of this technical design is possible to see especially in the fact that the mechanical control means are applicable for existing transport trucks, thereby it improves their usability whereas with application of mechanical-hydraulic means comes to significant innovation of this conception of the transport trucks which influences their usability not only in existing operational conditions yet enables use for transport of components and products in technologies which absorbs, parameters of a flow line production and also automatization.

1. A transport truck for transport of components, pellets, gitterboxes and similar is in the bottom part of a main frame equipped with at least one couple of vertical fixed pins for pivoting connection in the range of 360° into laterally deflected forks in which are pivoted wheels, wherein between the front and the rear wheels is transversally pivoted a shaft whose end parts are placed in bearing housings and are firmly fixed to pivoted scooter forks which are a fastener of foldable revolving wheels and the pivoted shaft is firmly fixed to at least one one-arm lever whose second end part is fixed, by the help of a pin, to control mechanical or mechanical-hydraulic means which are connected through a pin connection with a lever arm of a control lever which is together with a scooter fork with holes of a multifunctional shaft pivoted on a pin placed in a holder which is firmly fixed to the main frame of the transport truck.

2. The transport truck according to the claim 1, wherein the control mechanical means consist of a pull bar which is by its one end part through a pin connected with the end part of a pivoted one-arm lever which is firmly fixed to the shaft and the second end part of the pull bar is through a pin connection pivoted to a lower arm of an angular triple-arm controlling lever and a central arm and an upper arm of the controlling lever is equipped with a pass-through hole for connection with a slide-in pin with holes which are formed in a scooter fork ending of the multifunctional shaft.

3. The transport truck according to the claim 2, wherein the upper arm of the triple-arm controlling lever is equipped with a supporting cog which together with inserted slide-in pin in the hole of the scooter fork of the multifunctional shaft and with the holes in a fixed holder blocks vertical position of this multifunctional shaft and thereby forms a grip spot for manipulation with the transport truck.

4. The transport truck according to the claim 2, wherein the support cog in the upper arm of the triple-arm lever together with the inserted slide-in pin in the hole of the fixed holder blocks position of setting of the revolving wheels in a working vertical position and the horizontal position of the multifunctional shaft is a position which enables its parallel connection with another transport truck.

5. The transport truck according to the claim 1, wherein the mechanical-hydraulic control means consist of a sliding rod which is with its one end part connected, by the help of the pin, with the one-arm lever which is firmly fixed to the shaft and with the other end part is slide controlled by a piston of a direct single acting hydraulic piston whose pivoted control one-arm levers are through a pin and the pull bars connected with the lower arm of a two-arm lever which is together with the scooter fork with holes of the multifunctional shaft pivoted on the pin whose fastener is the fixed holder which is connected with the main frame of the transport truck.

6. The transport truck according to the claim 1, wherein the one-arm lever is firmly fixed by its one end part to the shaft and with the other end part connected with a draft spring whose second end part in anchored in a holder which is firmly fixed to the main frame of the transport truck.

7. The transport truck according to the claim 1, wherein the direct single acting hydraulic piston is equipped with locks which lock, in a pressure mode, position of the piston connected with the sliding rod.

8. The transport truck according to the claim 1, wherein between the front and the rear wheels is a transversally pivoted couple of shafts whose end parts are pivoted in bearing housings and are firmly fixed with pivoted scooter forks equipped with revolving preferably double wheels whereas the shafts are mutually connected with a connecting pull bar by the help of the pins and the one-arm levers which are firmly fixed on the shafts.

9. The transport truck according to the claim 1, wherein the outer diameter of foldable revolving wheels is bigger than the outer diameter of the wheels.

10. The transport truck according to the claim 5, wherein the one-arm lever is firmly fixed by its one end part to the shaft and with the other end part connected with a draft spring whose second end part in anchored in a holder which is firmly fixed to the main frame of the transport truck.

11. The transport truck according to the claim 5, wherein the direct single acting hydraulic piston is equipped with locks which lock, in a pressure mode, position of the piston connected with the sliding rod.

12. The transport truck according to the claim 5, wherein between the front and the rear wheels is a transversally pivoted couple of shafts whose end parts are pivoted in bearing housings and are firmly fixed with pivoted scooter forks equipped with revolving preferably double wheels whereas the shafts are mutually connected with a connecting pull bar by the help of the pins and the one-arm levers which are firmly fixed on the shafts.

13. The transport truck according to the claim 6, wherein between the front and the rear wheels is a transversally pivoted couple of shafts whose end parts are pivoted in bearing housings and are firmly fixed with pivoted scooter forks equipped with revolving preferably double wheels whereas the shafts are mutually connected with a connecting pull bar by the help of the pins and the one-arm levers which are firmly fixed on the shafts.

14. The transport truck according to the claim 2, wherein the outer diameter of foldable revolving wheels is bigger than the outer diameter of the wheels.

15. The transport truck according to the claim 3, wherein the outer diameter of foldable revolving wheels is bigger than the outer diameter of the wheels.

16. The transport truck according to the claim 4, wherein the outer diameter of foldable revolving wheels is bigger than the outer diameter of the wheels.

17. The transport truck according to the claim 5, wherein the outer diameter of foldable revolving wheels is bigger than the outer diameter of the wheels.

18. The transport truck according to the claim 6, wherein the outer diameter of foldable revolving wheels is bigger than the outer diameter of the wheels.

19. The transport truck according to the claim 7, wherein the outer diameter of foldable revolving wheels is bigger than the outer diameter of the wheels.

20. The transport truck according to the claim 8, wherein the outer diameter of foldable revolving wheels is bigger than the outer diameter of the wheels.
